(19) United States
(12) Patent Application Publication
(10) Pub. No.: US 2023/0245038 A1
(43) Pub. Date: Aug. 3, 2023

(54) SERIALIZED PRODUCT MANAGEMENT

(71) Applicant: Salesforce.com, inc., San Francisco, CA (US)

(72) Inventors: Prithvi Krishnan PADMANABHAN, San Ramon, CA (US); Yung CHEN, Alameda, CA (US); Reshma Vasant DIXIT, Walnut Creek, CA (US); Dai Duong DOAN, Alameda, CA (US); Puneet DHALIWAL, Dublin, CA (US)

(73) Assignee: Salesforce.com, inc., San Francisco, CA (US)

(21) Appl. No.: 17/649,497

(22) Filed: Jan. 31, 2022

(51) Int. Cl. G06Q 10/08

(52) U.S. Cl. CPC G06Q 10/0833; G06Q 10/087; G06Q 10/0835

(57) ABSTRACT

Some implementations of the disclosed systems, apparatus, methods and computer program products provide for shipping management of serialized products. In various embodiments, a product transfer record may be created to track the movement of a group of serialized items of a product from one location to another. A product transfer state may be provided for each of the serialized products within the transfer record. The product transfer state may then be updated to match the status of the transfer of the serialized item.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### FIELD OF TECHNOLOGY

This patent document relates generally to inventory management systems and more specifically to shipment management systems configured to provide for tracking and updating of status of individual serialized items.

### BACKGROUND

A product may be serialized. Serialized products may be high-value items, such as electronics equipment. Certain situations may require sending of only a portion of the serialized items that make up the stock of a product at a location (e.g., for maintenance purposes, only two step top boxes may be sent from the warehouse for an installation job).

Conventional shipment tracking techniques only track shipments, instead of tracking serialized items within shipments. Thus, typically, for tracking purposes, when sending and receiving serialized items, receiving users need to individually record or scan the serial number of the items to confirm that the items have been sent or received. Typically a single shipment includes a large number of serialized items for different products, requiring a large amount of time to record all the serial numbers.

### BRIEF DESCRIPTION OF THE DRAWINGS

The included drawings are for illustrative purposes and serve only to provide examples of possible structures and operations for the disclosed inventive systems, apparatus, methods and computer program products for serialized item shipment tracking. These drawings in no way limit any changes in form and detail that may be made by one skilled in the art without departing from the spirit and scope of the disclosed implementations.

FIG. 1 illustrates an example of a system for serialized item shipment tracking, configured in accordance with one or more embodiments.

FIG. 2 illustrates an example of a serialized item tracking sending technique, performed in accordance with one or more embodiments.

FIG. 3 illustrates an example of a serialized item tracking receiving technique, performed in accordance with one or more embodiments.

FIG. 4 illustrates a method of serialized item shipment, performed in accordance with one or more embodiments.

FIG. 5 shows a block diagram of an example of an environment that includes an on-demand multi-tenant resource service, configured in accordance with some embodiments.

FIGS. 6A and 6B illustrate examples of a computing system, configured in accordance with one or more embodiments.

FIG. 7 illustrates an example of a computing device, configured in accordance with one or more embodiments.

### DETAILED DESCRIPTION

Conventional shipment tracking techniques only track shipments or, at most, track individual products within a shipment. However, each individual product may include a plurality of serialized items and current techniques are unable to individually track such serialized items. Thus, typically, tracking of serialized items is performed manually, where a receiving user needs to individually record or scan the serial number of the serialized items when receiving the items to confirm that the received products include all their component items. Receipt of such products typically needs to be performed in a single session; otherwise the likelihood of serialized items being mistracked increases greatly. As the products need to be received in one session to confirm receipt, the serialized items must accordingly, in conventional techniques, be individually recorded or scanned in a single session.

Some implementations of the disclosed systems, apparatus, methods and computer program products are configured to provide for shipment management of serialized products. In various embodiments, a product transfer record may be created to track the movement of a group of serialized items of a product from one location to another. The product may be, for example, a single product that includes a plurality of serialized items. The product transfer record may be a part of a shipment that includes a plurality of product transfers.

For a product transfer record, a product transfer state may be provided for each of the serialized products. The product transfer state may then be updated to match the status of the transfer of the serialized product. The product transfer state may be specified and/or updated when the serialized item has been sent. Upon receipt, a product transfer state may be created for each received serialized item through scanning and/or by input from a receiving user. In certain embodiments, as the serialized items are individually tracked according to the techniques described herein, the product transfer state may be updated during a plurality of different sessions and/or from a plurality of different locations and/or by a plurality of different users.

Sean is a receiving technician of LotsOShips, a shipping company that includes branches in every state of the United States. Sean is currently receiving a shipment of computers for internal use. However, as the shipments have a history of certain items being lost in transit, Sean is required to confirm that all serialized items within each product of a shipment are present during receiving of the shipment. The current shipment has a large amount of products, and each product includes a large amount of serialized items. Sean is forced to organize the serialized item by product, note the receipt of each individual serialized item, which ends up requiring hours of overtime and forces him to miss his daughter's school Christmas play. Marital strife results.

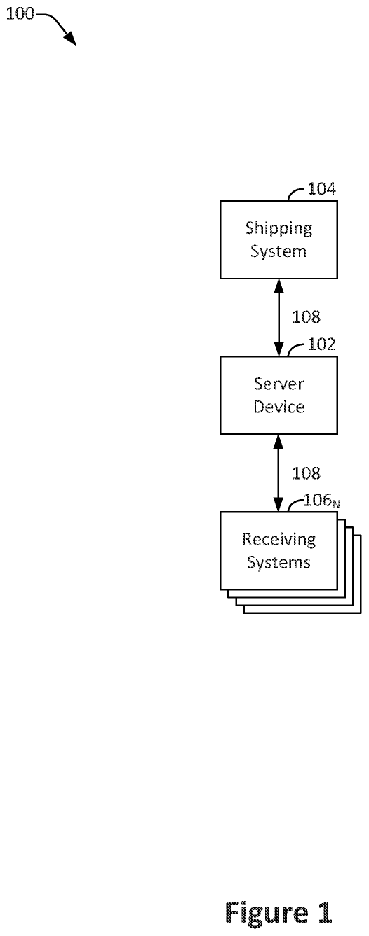

FIG. 1 illustrates an example of a system for serialized item shipment tracking, configured in accordance with one or more embodiments. FIG. 1 illustrates system 100 that includes server device 102, shipping system 104, and receiving systems 106_{N}. Shipping system 104 and receiving systems 106_{N} are each communicatively coupled to server device 102 via communications technique 108.

Server device 102 may provide for shipping management of serialized items. Server device 102 may include one or a plurality of server devices. Thus, for example, server device 102 may include a front facing server device configured to communicate with shipping system 104 and receiving systems 106_{N} and a back end server device that includes a plurality of Application Program Interfaces (APIs), such as APIs described herein, configured to provide shipping management of serialized items.

Shipping system 104 and receiving systems 106_{N} may be electronic devices associated with shippers and receivers, respectively, of the serialized items. One or both of shipping system 104 and receiving systems 106_{N} may include one or a plurality of electronic devices. The electronic devices may be any type of electronic device, such as a desktop computer, laptop computer, tablet, wearable electronic device, smart television, smartphone, and/or another such electronic device. Such electronic devices may include one or more software programs configured to receive inputs from a user and provide data (e.g., tracking data) to server device 102 and/or receive data from server device 102 and provide outputs to the user.

In various embodiments, shipping system 104 and/or receiving systems 106_{N} may be electronic device configured to receive user inputs identifying serialized items. Such user inputs may include, for example, a touchscreen, a keyboard, voice recognition, and/or other techniques for receiving user inputs. In certain embodiments, shipping system 104 and/or receiving systems 106_{N} may include one or more barcode scanners. The scanners may be configured to scan barcodes, Quick Response (QR) codes, and/or other types of scannable codes on the serialized items and/or the packaging of the serialized items. Such scanners may be used to scan the barcodes to send and/or receive the serialized items and indicate the status as such (e.g., through data communicated to server device 102 and stored within one or more databases of server device 102).

In various embodiments, shipping system 104 and receiving systems 106_{N} are each communicatively coupled to server device 102 via communications technique 108. Communications technique 108 may include any type of appropriate communications channel for communicating data, including wired or wireless communications channels such as Internet communications, Bluetooth, WiFi, Near Field Communications, Ethernet, Local Area Network, and/or other such communications channels or standards.

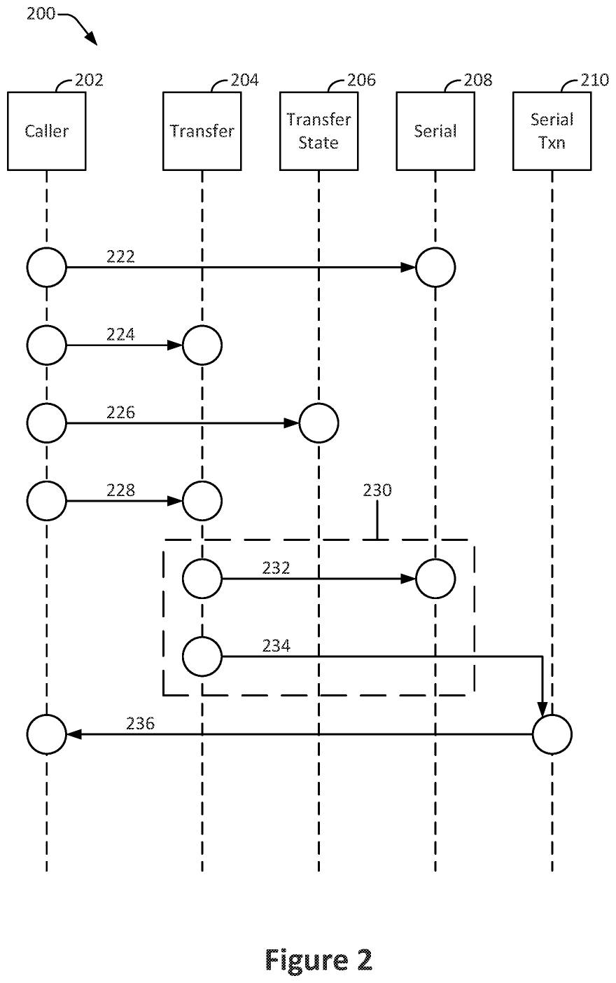

FIG. 2 illustrates an example of a serialized item tracking sending technique, performed in accordance with one or more embodiments. FIG. 2 illustrates serialized item tracking sending technique 200. Portions of serialized item tracking sending technique 200 may be performed by caller 202, transfer 204, transfer state 206, serial 208, and/or serial transaction 210. Variously, transfer 204, transfer state 206, serial 208, and serial transaction 210 may each be one or more APIs of server device 102 that may be called by caller 202.

Serial 208 may read, indicate, and track serialized items. The serialized items read, indicated, and/or tracked by serial 208 may be products or portions of products (e.g., a part of a product). In various embodiments, serial 208 may be configured to track individual serialized items of products. In certain such embodiments, serial 208 may receive the serial number of such serialized items through input, scanning, or another technique and track the shipment of such serialized items through such techniques.

Transfer 204 may be an API to indicate serialized items that are being transferred (e.g., from one member to another, one location to another, and/or otherwise transferred). In certain embodiments, transfer 204 may indicate the serialized items that are within each transfer (e.g., the serialized items indicated in serial 208). Transfer 204 may be configured to create and update the status of a product transfer and, accordingly, the serialized items within the products.

Transfer state 206 may be an API to indicate the state of the products within transfer 204. Transfer state 206 may, thus, provide data as to whether the products are sent, in transit, received, and/or another such status. In various embodiments, transfer state 206 may include a current status as well as store historical status (e.g., to provide for tracking and/or recall of the progress of shipment). In certain such embodiments, transfer state 206 may be an overarching state and, in certain situations, such as when transfer state 206 has received data indicating that the shipment has been sent, the state may be propagated to all serialized items within the shipment.

Serial transaction 210 may be an API configured to track the status of serialized items within the shipment. Thus, serial transaction 210 may be configured to, for example, track the status of each serialized item within the shipment. As such, for example, serial transaction 210 may receive data from various electronic devices and update the status of the various serialized items of a shipment. In various embodiments, serial transaction 210 may be an API configured to interface with serial 208 and cause the status of serialized items of serial 208 to be changed. In certain such embodiments, serial 208 may track the status of the serialized items while serial transaction 210 may be configured to create individual data records for each step of the shipping process.

In various embodiments, the system may be configured such that transfer 204 tracks the status of product shipments and serial 208 tracks the status of serialized items. As products and serialized items are two different categories of items, and certain serialized items may be products themselves (e.g., a cable that is a part of a laptop product may also be sold individually), such a configuration allows for independent tracking of products and serialized items in a resource efficient manner. In certain situations, only tracking of the product or the serialized item is desired and, thus, including separate APIs for the tracking of the product and/or the serialized item allows for API calls to be efficiently performed depending on the desired tracking. Furthermore, separate APIs for tracking of products and serialized items allows for simplification of the APIs used to track either, as the individual APIs are not required to distinguish between tracking products and tracking serialized items. User input and/or software on user electronic devices are used to distinguish between products and serialized items. The systems and techniques described herein allow for the tracking of both products and serialized products while utilizing such APIs, providing a resource efficient manner of tracking the shipment status of both categories.

Caller 202 may be one or more API callers. In certain embodiments, caller 202 may be one entity (e.g., one electronic device) or may be a plurality of entities (e.g., a plurality of electronic devices). For serialized item tracking sending technique 200, caller 202 may be one or more electronic devices associated with an entity that is shipping the products and serialized items.

For serialized item tracking sending technique 200, in 222, caller 202 may provide data identifying the serialized items to serial 208. Such data may be, for example, inputs identifying the serial numbers of the serialized items or scans of barcodes of the serialized items. In various embodiments, such data may be provided by shipping system 104 to serial 208, which may be an API provided by server device 102. In various embodiments, serial 208 may accordingly create one or more data records for the serialized items identified by such data. Such data records may, for example, be data records where a data record is associated with a single serialized item, or data records that may each identify a plurality of serialized items.

In 224, caller 202 may call transfer 204 and provide data to create a new product transfer shipment. The data may be from shipping system 104 and may identify the products that are to be shipped, as well as other information such as sender, recipient, destination address, shipment carrier, estimated shipping time, and/or other such information. Based on such data, transfer 204 create one or more new product transfer shipment data records to allow for tracking of the product transfer. The product transfer shipment data records may allow for tracking of individual products and/or, when utilizing serial 208, tracking of individual serialized items. In certain embodiments, caller 202 may provide data of the serialized items to transfer 204, referencing the data records associated with the individual serialized items provided to serial 208.

In 226, caller 202 may call transfer state 206 and provide data to create transfer states for each of the data records created by transfer 204 in 224. The transfer states may indicate that the various products and/or serialized items created in 224 are ready to be transferred and, thus, may be updated.

The transfer states may be updated by transfer 204, via data received in 228 from caller 202. Such data received may include data indicating that one or more products within the shipment, or the full shipment itself, has been sent.

Based on the receipt of such data, loop 230 may be performed to update the status for each of the serialized items or each data record. Accordingly, upon receipt of data indicating that the shipment has been shipped (e.g., is in transit), the API of transfer 204 may identify the products and/or serialized items that are a part of the transfer and the associated data records (e.g., the data records associated with the products and/or the serialized items of the products). After identification of the products and/or serialized items within the transfer, loop 230 may be performed for each of the serialized items.

In loop 230, transfer 204 may identify each of the serialized items within the shipment. Transfer 204 may identify the serialized items by, for example, the serial number of the items and/or the associated codes (e.g., barcode or QR code) associated with the individual serialized item. Transfer 204 then provides data to serial 208 for each serialized item, indicating the change in status for the serialized item (e.g., that the serialized item has shipped). Transfer 204 also provides data to serial transaction 210 for each serialized item. Serial transaction 210 may then create a data record for the shipment step for each serialized item sent. Confirmation of the shipment of each serialized item may then be provided to caller 202, in 236, to indicate that the serialized item has been sent.

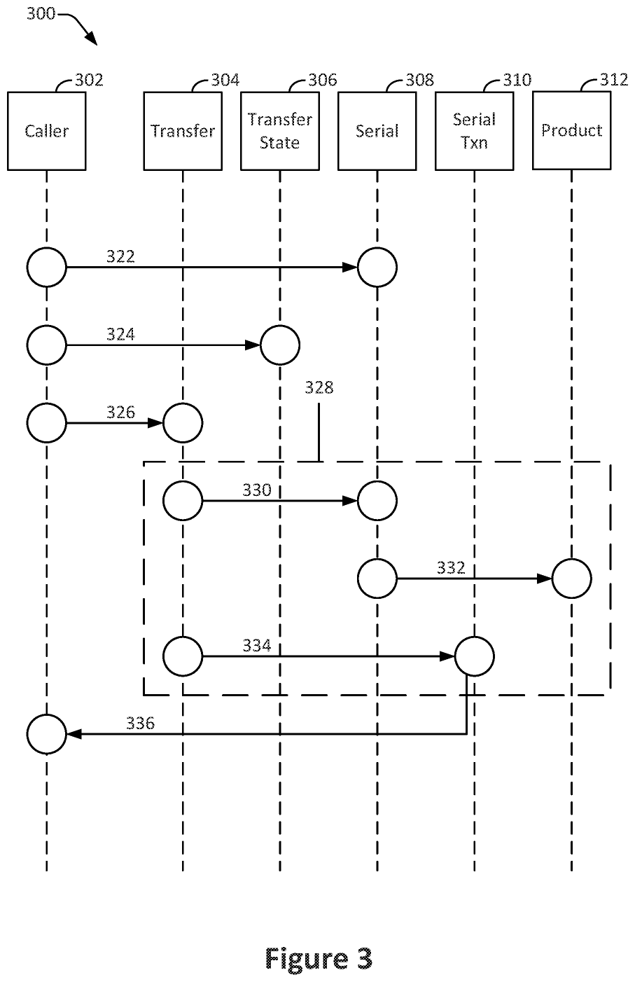

FIG. 3 illustrates an example of a serialized item tracking receiving technique, performed in accordance with one or more embodiments. FIG. 3 illustrates serialized item tracking receiving technique 300. Portions of serialized item tracking receiving technique 300 may be performed by caller 302, transfer 304, transfer state 306, serial 308, serial transaction 310, and/or product 312. Variously, transfer 304, transfer state 306, serial 308, serial transaction 310, and product 312 may each be one or more APIs of server device 102 that may be called by caller 302. In certain embodiments, transfer 304, transfer state 306, serial 308, and serial transaction 310 may be similar to transfer 204, transfer state 206, serial 208, and serial transaction 210 of FIG. 2.

Product 312 may be configured to track and/or provide data indicating the amount of stock of a particular product or serialized item at a particular location. Thus, in certain embodiments, product 312 may be an API that allows for tracking of the quantity of products and/or serialized items within various locations (e.g., may provide data related to inventory at the particular location). Product 312 may also store and/or provide data of actions taken for products and/or serialized items in field service. Such data may be auto-generated data records that aid in tracking of when a product or serialized item is replenished, consumed, or adjusted.

Caller 302 may be one or more API callers. In certain embodiments, caller 302 may be one entity (e.g., one electronic device) or may be a plurality of entities (e.g., a plurality of electronic devices). For serialized item tracking receiving technique 300, caller 302 may be one or more electronic devices associated with an entity that is receiving the products and/or the serialized items.

In 322, caller 302 may indicate the receipt of one or more serialized items. Such receipt may be indicated through the user providing inputs indicating receipt of the serialized items (e.g., by inputting the serial numbers of serialized items through a user interface), via scanning of barcodes of the serialized items, and/or via another such technique. Such data may, thus, indicate the serial numbers of the serialized items that have been received. The electronic device of caller 302 may communicate such data to server device 102. Serial 308 may receive such data via an API call. Accordingly, serial 308 may receive data identifying serialized items that have been received.

In 324, caller 302 may call transfer state 306 to create transfer states for the various serialized items that have been received (e.g., identified in 322 or previous to 322 via input or scanning). With the new transfer states created for the received serialized items, an update may be provided to transfer 304 indicating that the serialized items have been received. The transfer states may, thus, indicate that the various products and/or serialized items have been received.

Based on the receipt of such data, loop 328 may be performed to update the status of the serialized items within the shipment. Accordingly, upon receipt of data updating the status of the serialized items, the API of transfer 304 may identify the products and/or serialized items that have been received and the associated data records. After identification of the products and/or serialized items received, loop 328 may be performed for each of the serialized items or each data record.

In loop 328, transfer 304 may identify the serialized item or the data record of the serialized items received by, for example, the serial number of the items and/or the associated codes (e.g., barcode or QR code) associated with the individual serialized item. Transfer 304 then provides data to serial 308 for each serialized item, indicating the change in status for the serialized item (e.g., that the serialized item has been received).

Based on receipt of the data, serial 308 then provides data to product 312 to update the quantity on hand of the serialized items within the location. Product 312 may thus receive the data and indicate that the serialized items are present at the receiving location. Based on the serialized items being received, product 312 may additionally update a product or item data record associated with the amount of such items at the location. Such a data record may allow for tracking of whether the serialized item is replenished, consumed, or adjusted.

Furthermore, transfer 304 provides data to serial transaction 310 for each serialized item. Serial transaction 310 may then create a data record associated with the receipt step of each serialized item sent. Confirmation of the receipt of each serialized item may then be provided to caller 302, in 336, to indicate that the serialized item has been received.

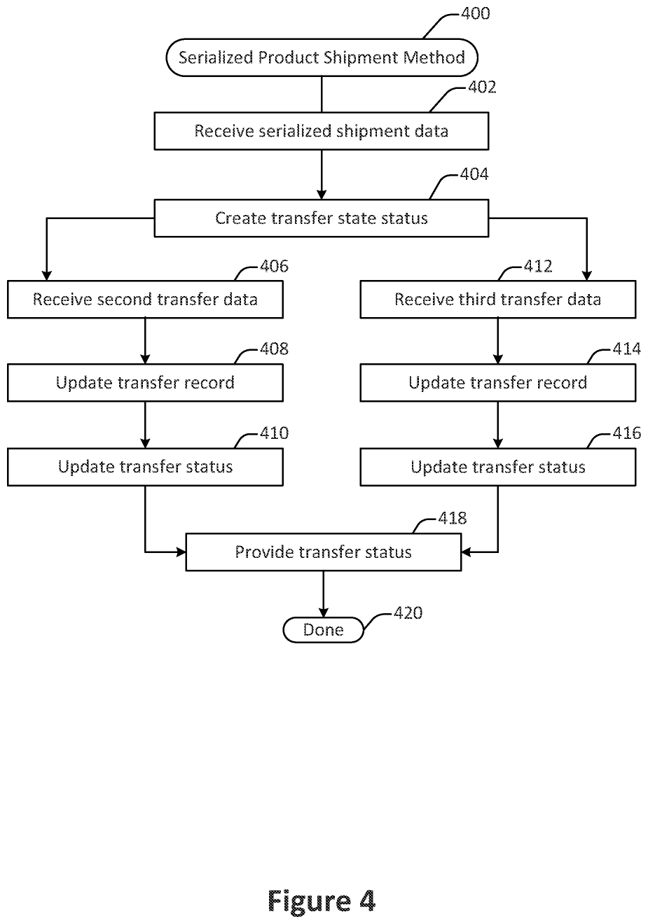

FIG. 4 illustrates a method of serialized item shipment, performed in accordance with one or more embodiments. FIG. 4 illustrates serialized product shipment method 400. Serialized product shipment method 400 may be performed according to the systems and other techniques described herein. Thus, serialized product shipment method 400 may, additionally or alternatively, incorporate details of the techniques described herein in FIGS. 2 and 3.

In 402, the server device may receive serialized shipment data. The serialized shipment data may be provided by an electronic device associated with the shipper (e.g., by shipping system 102). The serialized shipment data may include date indicating the products and/or serialized items that are shipped, as well as the quantity, origin, destination, target time of arrival, and/or other such data. The serialized shipment data may additionally include a status for the items (e.g., about to be shipped, in the process of shipping, and/or another such status).

Upon receipt of the shipment data in 402, the transfer state status may be created in 404. Variously, the transfer state status may include shipment status (e.g., packing to be shipped, shipped, on hold, and/or another such status) related to the shipment, the products of the shipment, the serialized items of the shipment, unserialized items within the shipment, and/or other such items. In various embodiments, the transfer state status may indicate a status for each serialized item within the shipment. In certain such embodiments, once an indication has been received (e.g., from shipping system 102) that a serialized item has been shipped, the status category of that serialized item may be updated to a shipped status and then locked to prevent further updates until data indicating receipt of the item has been provided. In such an embodiment, shipment of the serialized item may include data directed to the overall shipment, the product, the serialized item, and/or other such data (e.g., as described herein in FIGS. 2 and 3) and one or more of such data may be locked until a further API call from a receiving electronic device is received. The serialized item may then be shipped (along with the rest of the shipment).

The shipment may be provided to one or a plurality of different receiving locations. The techniques described herein may allow for receipt of the shipment at one or a plurality of different locations, as each serialized item includes separate data records and receipt of the serialized items generates separate data records, regardless of whether a plurality of serialized items are a part of one product. Accordingly, the serialized items of the shipment may be received by one or a plurality of different receivers at one or a plurality of receiving sessions.

Thus, second transfer data and third transfer data may be received from different receiving users, in 406 and 412. Receipt of such data may be via any of the techniques described herein, and the received data may indicate the serialized items received as well as the location, identity of the user, time, and/or other such data associated with receipt of the serialized items.

In certain embodiments, data associated with the receipt of the serialized item may be obtained by an electronic device and stored within the electronic device until the electronic device communicates the data to the server device (e.g., the electronic device may receive the serialized item through, for example, scanning of a barcode of the serialized item and then communicate such data to the server device when the electronic device has an Internet connection to the server device). As the serialized items include separate data records, according to the techniques described herein, the receipt of different items may be processed in different stages. Furthermore, the transfer status of each serialized item may be locked until receipt data is received. Thus, the techniques described herein allow for the receipt of items while no network connection is present, before the receipt is then communicated once a network connection is present.

Based on the transfer data received, the transfer records of the respective serialized items may be updated on 408 and 414. The transfer record may be updated to allow for the changing of the transfer status of the associated serialized items. The transfer status may then be accordingly updated in 410 and 416.

The transfer record may be the records associated with transfer of the product. Thus, for example, 322, 324, and 326 of technique 300 may be associated with updating of the transfer record. The transfer status may be associated with the individual status of the serialized item. Accordingly, for example, 330, 332, and 334 of technique 300 may be associated with updating the transfer status.

Based on the receipt of the serialized items, the updated transfer status may be provided (e.g., to the receiver, shipper, entity providing the shipping, and/or another party) in 418.

The systems and techniques described herein allow for assignment of different portions of the shipping and receiving techniques to be assigned to different user profiles. For example, the shipping technique may be assigned only to users (e.g., based on their role within their user profile) that are qualified for shipping, and the receiving technique may only be assigned to users that are qualified for receiving.

Based on Sean's recommendation, LotsOShips has adopted the serialized shipping technique described herein. The technique allows for Sean to receive shipments over a plurality of different sessions and to hand off the receiving to a different technician should he be received to step away. Sean is thus able to better budget his time for receiving of items and is able to attend the school functions of his daughter. His relationship with his wife has also improved.

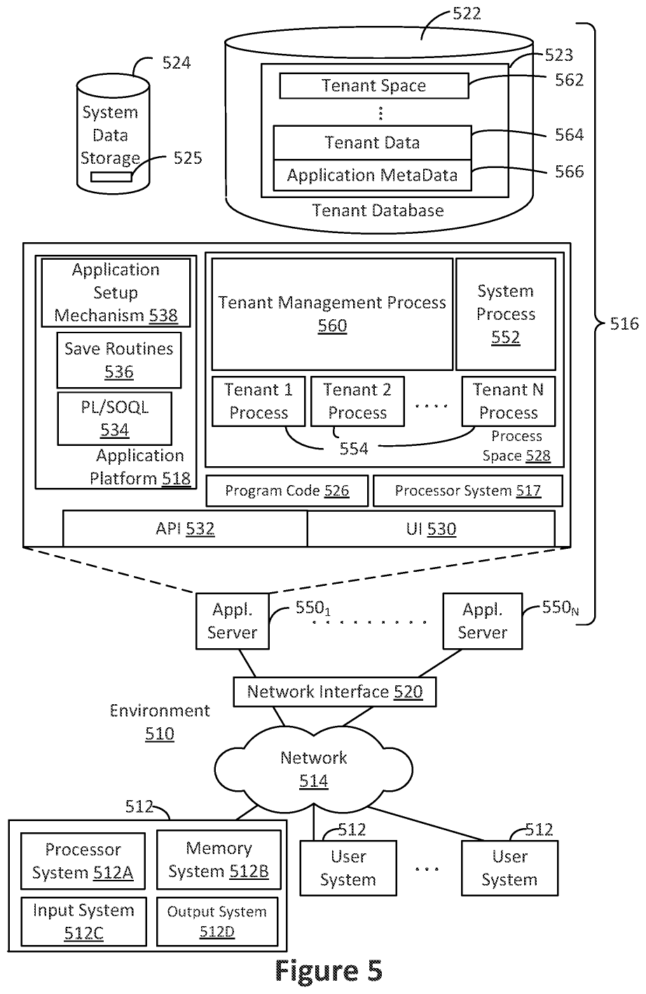

FIG. 5 shows a block diagram of an example of an environment 510 that includes an on-demand database service configured in accordance with some implementations. Environment 510 may include user systems 512, network 514, database system 516, processor system 517, application platform 518, network interface 520, tenant data storage 522, tenant data 523, system data storage 524, system data 525, program code 526, process space 528, User Interface (UI) 530, Application Program Interface (API) 532, PL/SOQL 534, save routines 536, application setup mechanism 538, application servers 550-1 through 550-N, system process space 552, tenant process spaces 554, tenant management process space 560, tenant storage space 562, user storage 564, and application metadata 566. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 516, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 518 may be a framework that allows the creation, management, and execution of applications in system 516. Such applications may be developed by the database service provider or by users or third-party application developers accessing the service. Application platform 518 includes an application setup mechanism 538 that supports application developers' creation and management of applications, which may be saved as metadata into tenant data storage 522 by save routines 536 for execution by subscribers as one or more tenant process spaces 554 managed by tenant management process 560 for example. Invocations to such applications may be coded using PL/SOQL 534 that provides a programming language style interface extension to API 532. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 566 for a subscriber making such an invocation. Such system processes may also manage execution of application metadata 566 as an application in a virtual machine.

In some implementations, each application server 550 may handle requests for any user associated with any organization. A load balancing function (e.g., an F5 Big-IP load balancer) may distribute requests to the application servers 550 based on an algorithm such as least-connections, round robin, observed response time, etc. Each application server 550 may be configured to communicate with tenant data storage 522 and the tenant data 523 therein, and system data storage 524 and the system data 525 therein to serve requests of user systems 512. The tenant data 523 may be divided into individual tenant storage spaces 562, which can be either a physical arrangement and/or a logical arrangement of data. Within each tenant storage space 562, user storage 564 and application metadata 566 may be similarly allocated for each user. For example, a copy of a user's most recently used (MRU) items might be stored to user storage 564. Similarly, a copy of MRU items for an entire tenant organization may be stored to tenant storage space 562. A UI 530 provides a user interface and an API 532 provides an application programming interface to system 516 resident processes to users and/or developers at user systems 512.

System 516 may implement a serialized product management system. For example, in some implementations, system 516 may include application servers configured to implement and execute serialized product management software applications. The application servers may be configured to provide related data, code, forms, web pages and other information to and from user systems 512. Additionally, the application servers may be configured to store information to, and retrieve information from a database system. Such information may include related data, objects, and/or Webpage content. With a multi-tenant system, data for multiple tenants may be stored in the same physical database object in tenant data storage 522, however, tenant data may be arranged in the storage medium(s) of tenant data storage 522 so that data of one tenant is kept logically separate from that of other tenants. In such a scheme, one tenant may not access another tenant's data, unless such data is expressly shared.

Several elements in the system shown in FIG. 5 include conventional, well-known elements that are explained only briefly here. For example, user system 512 may include processor system 512A, memory system 512B, input system 512C, and output system 512D. A user system 512 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 512 to access, process and view information, pages and applications available from system 516 over network 514. Network 514 may be any network or combination of networks of devices that communicate with one another, such as any one or any combination of a LAN (local area network), WAN (wide area network), wireless network, or other appropriate configuration.

The users of user systems 512 may differ in their respective capacities, and the capacity of a particular user system 512 to access information may be determined at least in part by “permissions” of the particular user system 512. As discussed herein, permissions generally govern access to computing resources such as data objects, components, and other entities of a computing system, such as a serialized product management system, a social networking system, and/or a CRM database system. “Permission sets” generally refer to groups of permissions that may be assigned to users of such a computing environment. For instance, the assignments of users and permission sets may be stored in one or more databases of System 516. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 516 may provide on-demand database service to user systems 512 using an MTS arrangement. By way of example, one tenant organization may be a company that employs a sales force where each salesperson uses system 516 to manage their sales process. Thus, a user in such an organization may maintain contact data, leads data, customer follow-up data, performance data, goals and progress data, etc., all applicable to that user's personal sales process (e.g., in tenant data storage 522). In this arrangement, a user may manage his or her sales efforts and cycles from a variety of devices, since relevant data and applications to interact with (e.g., access, view, modify, report, transmit, calculate, etc.) such data may be maintained and accessed by any user system 512 having network access.

When implemented in an MTS arrangement, system 516 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 516 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 516 may also maintain system-level data usable by multiple tenants or other data. Such system-level data may include industry reports, news, postings, and the like that are sharable between tenant organizations.

In some implementations, user systems 512 may be client systems communicating with application servers 550 to request and update system-level and tenant-level data from system 516. By way of example, user systems 512 may send one or more queries requesting data of a database maintained in tenant data storage 522 and/or system data storage 524. An application server 550 of system 516 may automatically generate one or more SQL statements (e.g., one or more SQL queries) that are designed to access the requested data. System data storage 524 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

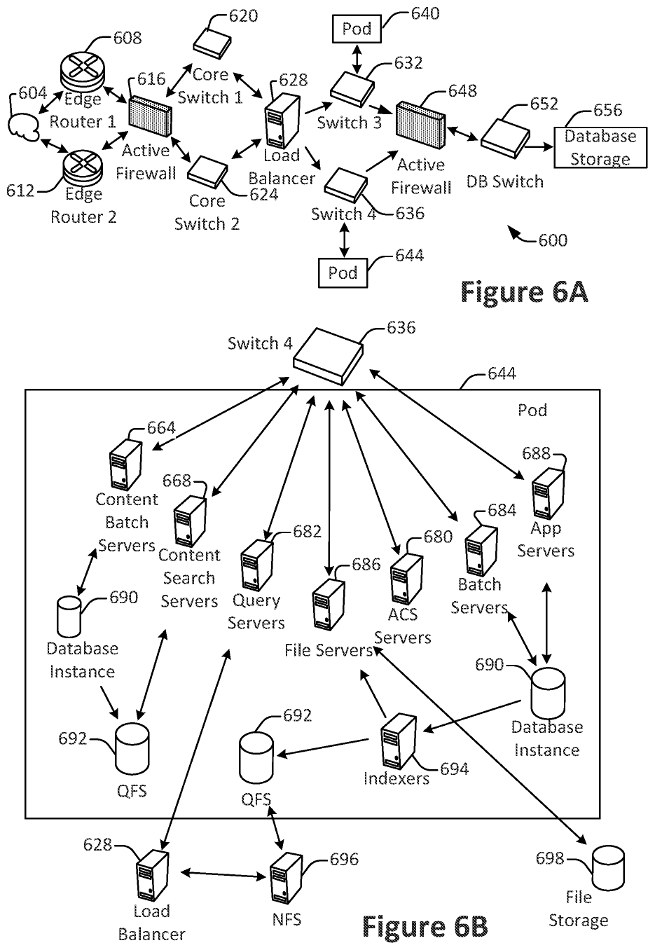

FIG. 6A shows a system diagram of an example of architectural components of an on-demand database service environment 600, configured in accordance with some implementations. A client machine located in the cloud 604 may communicate with the on-demand database service environment via one or more edge routers 608 and 612. A client machine may include any of the examples of user systems 512 described above. The edge routers 608 and 612 may communicate with one or more core switches 620 and 624 via firewall 616. The core switches may communicate with a load balancer 628, which may distribute server load over different pods, such as the pods 640 and 644 by communication via pod switches 632 and 636. The pods 640 and 644, which may each include one or more servers and/or other computing resources, may perform data processing and other operations used to provide on-demand services. Components of the environment may communicate with a database storage 656 via a database firewall 648 and a database switch 652.

Accessing an on-demand database service environment may involve communications transmitted among a variety of different components. The environment 600 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 6A and 6B.

The cloud 604 refers to any suitable data network or combination of data networks, which may include the Internet. Client machines located in the cloud 604 may communicate with the on-demand database service environment 600 to access services provided by the on-demand database service environment 600. By way of example, client machines may access the on-demand database service environment 600 to retrieve, store, edit, and/or process shipment information.

In some implementations, the edge routers 608 and 612 route packets between the cloud 604 and other components of the on-demand database service environment 600. The edge routers 608 and 612 may employ the Border Gateway Protocol (BGP). The edge routers 608 and 612 may maintain a table of IP networks or ‘prefixes’, which designate network reachability among autonomous systems on the internet.

In one or more implementations, the firewall 616 may protect the inner components of the environment 600 from internet traffic. The firewall 616 may block, permit, or deny access to the inner components of the on-demand database service environment 600 based upon a set of rules and/or other criteria. The firewall 616 may act as one or more of a packet filter, an application gateway, a stateful filter, a proxy server, or any other type of firewall.

In some implementations, the core switches 620 and 624 may be high-capacity switches that transfer packets within the environment 600. The core switches 620 and 624 may be configured as network bridges that quickly route data between different components within the on-demand database service environment. The use of two or more core switches 620 and 624 may provide redundancy and/or reduced latency.

In some implementations, communication between the pods 640 and 644 may be conducted via the pod switches 632 and 636. The pod switches 632 and 636 may facilitate communication between the pods 640 and 644 and client machines, for example via core switches 620 and 624. Also or alternatively, the pod switches 632 and 636 may facilitate communication between the pods 640 and 644 and the database storage 656. The load balancer 628 may distribute workload between the pods, which may assist in improving the use of resources, increasing throughput, reducing response times, and/or reducing overhead. The load balancer 628 may include multilayer switches to analyze and forward traffic.

In some implementations, access to the database storage 656 may be guarded by a database firewall 648, which may act as a computer application firewall operating at the database application layer of a protocol stack. The database firewall 648 may protect the database storage 656 from application attacks such as structure query language (SQL) injection, database rootkits, and unauthorized information disclosure. The database firewall 648 may include a host using one or more forms of reverse proxy services to proxy traffic before passing it to a gateway router and/or may inspect the contents of database traffic and block certain content or database requests. The database firewall 648 may work on the SQL application level atop the TCP/IP stack, managing applications' connection to the database or SQL management interfaces as well as intercepting and enforcing packets traveling to or from a database network or application interface.

In some implementations, the database storage 656 may be an on-demand database system shared by many different organizations. The on-demand database service may employ a single-tenant approach, a multi-tenant approach, a virtualized approach, or any other type of database approach. Communication with the database storage 656 may be conducted via the database switch 652. The database storage 656 may include various software components for handling database queries. Accordingly, the database switch 652 may direct database queries transmitted by other components of the environment (e.g., the pods 640 and 644) to the correct components within the database storage 656.

FIG. 6B shows a system diagram further illustrating an example of architectural components of an on-demand database service environment, in accordance with some implementations. The pod 644 may be used to render services to user(s) of the on-demand database service environment 600. The pod 644 may include one or more content batch servers 664, content search servers 668, query servers 682, file servers 686, access control system (ACS) servers 680, batch servers 684, and app servers 688. Also, the pod 644 may include database instances 690, quick file systems (QFS) 692, and indexers 694. Some or all communication between the servers in the pod 644 may be transmitted via the switch 636.

In some implementations, the app servers 688 may include a framework dedicated to the execution of procedures (e.g., programs, routines, scripts) for supporting the construction of applications provided by the on-demand database service environment 600 via the pod 644. One or more instances of the app server 688 may be configured to execute all or a portion of the operations of the services described herein.

In some implementations, as discussed above, the pod 644 may include one or more database instances 690. A database instance 690 may be configured as an MTS in which different organizations share access to the same database, using the techniques described above. Database information may be transmitted to the indexer 694, which may provide an index of information available in the database 690 to file servers 686. The QFS 692 or other suitable filesystem may serve as a rapid-access file system for storing and accessing information available within the pod 644. The QFS 692 may support volume management capabilities, allowing many disks to be grouped together into a file system. The QFS 692 may communicate with the database instances 690, content search servers 668 and/or indexers 694 to identify, retrieve, move, and/or update data stored in the network file systems (NFS) 696 and/or other storage systems.

In some implementations, one or more query servers 682 may communicate with the NFS 696 to retrieve and/or update information stored outside of the pod 644. The NFS 696 may allow servers located in the pod 644 to access information over a network in a manner similar to how local storage is accessed. Queries from the query servers 622 may be transmitted to the NFS 696 via the load balancer 628, which may distribute resource requests over various resources available in the on-demand database service environment 600. The NFS 696 may also communicate with the QFS 692 to update the information stored on the NFS 696 and/or to provide information to the QFS 692 for use by servers located within the pod 644.

In some implementations, the content batch servers 664 may handle requests internal to the pod 644. These requests may be long-running and/or not tied to a particular customer, such as requests related to log mining, cleanup work, and maintenance tasks. The content search servers 668 may provide query and indexer functions such as functions allowing users to search through content stored in the on-demand database service environment 600. The file servers 686 may manage requests for information stored in the file storage 698, which may store information such as documents, images, basic large objects (BLOBS), etc. The query servers 682 may be used to retrieve information from one or more file systems. For example, the query system 682 may receive requests for information from the app servers 688 and then transmit information queries to the NFS 696 located outside the pod 644. The ACS servers 680 may control access to data, hardware resources, or software resources called upon to render services provided by the pod 644. The batch servers 684 may process batch jobs, which are used to run tasks at specified times. Thus, the batch servers 684 may transmit instructions to other servers, such as the app servers 688, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

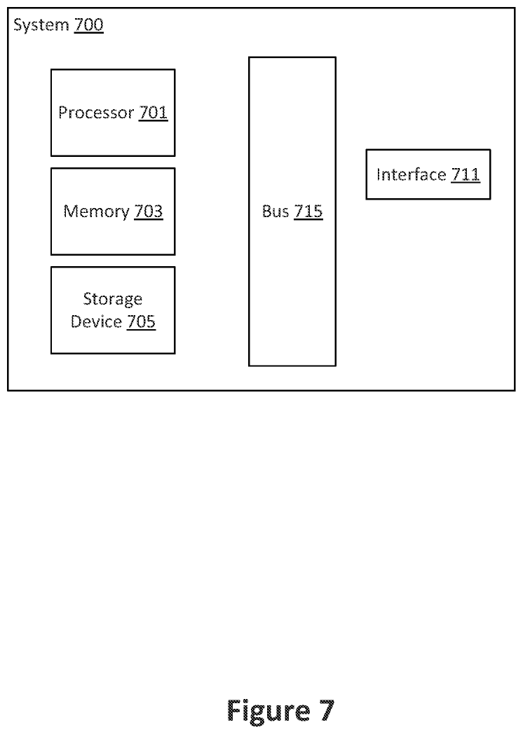

FIG. 7 illustrates one example of a computing device. According to various embodiments, a system 700 suitable for implementing embodiments described herein includes a processor 701, a memory module 703, a storage device 705, an interface 711, and a bus 715 (e.g., a PCI bus or other interconnection fabric.) System 700 may operate as variety of devices such as an application server, a database server, or any other device or service described herein. Although a particular configuration is described, a variety of alternative configurations are possible. The processor 701 may perform operations such as those described herein. Instructions for performing such operations may be embodied in the memory 703, on one or more non-transitory computer readable media, or on some other storage device. Various specially configured devices can also be used in place of or in addition to the processor 701. The interface 711 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A system comprising:
a database; and
a processor, communicatively coupled to the database and configured to perform operations comprising:
receiving, at a first time period and from a first user device, first transfer data associated with a first shipment, wherein the first transfer data identifies a plurality of first serialized products of a first product type and a transfer state for one or more of the plurality of first serialized products;
creating and storing, within the database and based on the first transfer data, a first transfer record, wherein the first transfer record comprises a plurality of status categories and is configured to prevent updates for one or more of the status categories;
receiving, at a second time period and from a second user device, second transfer data associated with the first shipment, wherein the second transfer data identifies a first number of the plurality of first serialized products and an updated transfer state for one or more of the first number of the plurality of first serialized products, wherein the first number is less than the plurality;
updating, based on the second transfer data, the first transfer record to allow updates to the one or more of the status categories of the first number of the plurality of first serialized products;
receiving, at a third time period, third transfer data associated with the first shipment, wherein the third transfer data identifies a second number of the plurality of first serialized products and an updated transfer state for one or more of the second number of the plurality of first serialized products; and
updating, based on the third transfer data, the first transfer record to allow updates to the one or more of the status categories of the second number of the plurality of first serialized products.

2. The system of claim 1, wherein the third transfer data is received from a third user device.

3. The system of claim 2, wherein the second user device is associated with a first user and the third user device is associated with a second user.

4. The system of claim 1, wherein the second time period and the third time period are different time periods.

5. The system of claim 1, wherein the operations further comprise:
receiving fourth transfer data identifying the first number of the plurality of first serialized products and a received transfer state for one or more of the first number of the plurality of first serialized products; and
updating, based on the fourth transfer data, the transfer state of the first number of the plurality of first serialized products.

6. The system of claim 5, wherein the updated transfer state is a received state.

7. The system of claim 1, wherein the second transfer data is received from a first location and the third transfer data is received from a second location different from the first location.

8. The system of claim 1, wherein the second transfer data is stored within the second user device before being provided to the processor.

2. A method comprising:
receiving, at a first time period and from a first user device, first transfer data associated with a first shipment, wherein the first transfer data identifies a plurality of first serialized products of a first product type and a transfer state for one or more of the plurality of first serialized products;
creating and storing, within a database and based on the first transfer data, a first transfer record, wherein the first transfer record comprises a plurality of status categories and is configured to prevent updates for one or more of the status categories;
receiving, at a second time period and from a second user device, second transfer data associated with the first shipment, wherein the second transfer data identifies a first number of the plurality of first serialized products and an updated transfer state for one or more of the first number of the plurality of first serialized products, wherein the first number is less than the plurality;
updating, based on the second transfer data, the first transfer record to allow updates to the one or more of the status categories of the first number of the plurality of first serialized products;
receiving, at a third time period, third transfer data associated with the first shipment, wherein the third transfer data identifies a second number of the plurality of first serialized products and an updated transfer state for one or more of the second number of the plurality of first serialized products; and
updating, based on the third transfer data, the first transfer record to allow updates to the one or more of the status categories of the second number of the plurality of first serialized products.

10. The method of claim 9, wherein the third transfer data is received from a third user device.

11. The method of claim 10, wherein the second user device is associated with a first user and the third user device is associated with a second user.

12. The method of claim 9, wherein the second time period and the third time period are different time periods.

13. The method of claim 9, further comprising:
receiving fourth transfer data identifying the first number of the plurality of first serialized products and a received transfer state for one or more of the first number of the plurality of first serialized products; and
updating, based on the fourth transfer data, the transfer state of the first number of the plurality of first serialized products.

14. The method of claim 13, wherein the updated transfer state is a received state.

15. The method of claim 9, wherein the second transfer data is received from a first location and the third transfer data is received from a second location different from the first location.

3. A computer program product comprising computer-readable program code capable of being executed by one or more processors when retrieved from a non-transitory computer-readable medium, the program code comprising instructions configurable to cause:
receiving, at a first time period and from a first user device, first transfer data associated with a first shipment, wherein the first transfer data identifies a plurality of first serialized products of a first product type and a transfer state for one or more of the plurality of first serialized products;
creating and storing, within a database and based on the first transfer data, a first transfer record, wherein the first transfer record comprises a plurality of status categories and is configured to prevent updates for one or more of the status categories;
receiving, at a second time period and from a second user device, second transfer data associated with the first shipment, wherein the second transfer data identifies a first number of the plurality of first serialized products and an updated transfer state for one or more of the first number of the plurality of first serialized products, wherein the first number is less than the plurality;
updating, based on the second transfer data, the first transfer record to allow updates to the one or more of the status categories of the first number of the plurality of first serialized products;
receiving, at a third time period, third transfer data associated with the first shipment, wherein the third transfer data identifies a second number of the plurality of first serialized products and an updated transfer state for one or more of the second number of the plurality of first serialized products; and
updating, based on the third transfer data, the first transfer record to allow updates to the one or more of the status categories of the second number of the plurality of first serialized products.

17. The computer program product of claim 16, wherein the third transfer data is received from a third user device.

18. The computer program product of claim 17, wherein the second user device is associated with a first user and the third user device is associated with a second user.

19. The computer program product of claim 16, wherein the second time period and the third time period are different time periods.

20. The computer program product of claim 16, wherein the instructions are further configurable to cause:
receiving fourth transfer data identifying the first number of the plurality of first serialized products and a received transfer state for one or more of the first number of the plurality of first serialized products; and
updating, based on the fourth transfer data, the transfer state of the first number of the plurality of first serialized products.
